(19) United States
(12) Patent Application Publication
(10) Pub. No.: US 2013/0112785 A1
(43) Pub. Date: May 9, 2013

(54) METHODS AND APPARATUS FOR SAMPLE FRACTURING

(71) Applicant: DOW AGROSCIENCES LLC, Indianapolis, IN (US)

(72) Inventors: Sandra Grace Toledo, West Lafayette, IN (US); Marcelo Julio Sosa, West Lafayette, IN (US)

(73) Assignee: DOW AGROSCIENCES LLC, Indianapolis, IN (US)

(21) Appl. No.: 13/660,144

(22) Filed: Oct. 25, 2012

Related U.S. Application Data
(60) Provisional application No. 61/556,208, filed on Nov. 5, 2011.

(51) Int. Cl. B02C 1/04

(52) U.S. Cl. 241/6; 241/199.11; 241/27

(57) ABSTRACT

An apparatus is disclosed which may be used to homogenize a sample in a container. In one embodiment, the apparatus includes a container and a cap with a fracturing member rigidly attached to the cap such that the fracturing member engages a sample as the cap is coupled to the container. In an example embodiment, the container is a test tube and the sample is a seed, such as a corn kernel. Methods of fracturing samples in containers with fracturing members rigidly attached to caps are also disclosed.

### RELATED APPLICATIONS

This application claims the benefit of U.S. Provisional Application Ser. No. 61/556,208, filed Nov. 5, 2011, titled METHODS AND APPARATUS FOR SAMPLE FRACTURING, docket DAS-P0216-US, the disclosure of which is expressly incorporated by reference herein.

### FIELD

The present invention relates to methods and apparatus for fracturing samples and in particular to methods and apparatus for fracturing hard exterior samples in an interior of a container.

### BACKGROUND

Homogenization of maize kernels requires the fracturing of the hard exterior of maize kernels. This currently is a labor intensive process that is accomplished manually or through using commercially available homogenizers. Manual grinding is time consuming, ergonomically challenging, and may be a source of cross-contamination if the grinding device is not properly cleaned between samples. The same cross-contamination risk is present when using low-throughput grinding mills.

Steel beads have also been used to attempt to fracture the hard exterior of the maize kernels. The steel beads are placed within a test tube holding the kernel to be fractured. However, fracturing of the kernels is minimal.

A device is desired which may quickly and effectively fracture hard exterior samples, such as maize kernels, while minimizing cross-contamination. By providing improved fracturing of the maize kernels, improved differentiation between positive and negative results in later analysis, such as enzyme-linked immunosorbent assay (“ELISA”) testing for a given protein may be achieved.

### SUMMARY

In an exemplary embodiment of the present disclosure, a fracturing apparatus is provided. The fracturing apparatus comprising a container including a bottom and an open top and a cap including a first portion removably coupled to the container and a second portion including a fracturing member extending downward from the first portion. An interior of the container being accessible through the open top. When the cap is coupled to the container the fracturing member extends through the interior of the container and a lower end of the fracturing member is proximate to the bottom of the container. The lower end of the fracturing member being in a fixed position relative to the first portion of the cap.

In another exemplary embodiment of the present disclosure, a fracturing apparatus is provided, The fracturing apparatus comprising a container including a bottom and an open top, an interior of the container being accessible through the open top; a container support which positions the container in a first orientation; a cap including a first portion removably coupled to the container and a second portion including a fracturing member extending downward from the first portion; a cap support which supports the cap in a second orientation, wherein in the second orientation the fracturing member is positioned directly over the bottom of the container; and an actuator which changes the orientation of at least one of the container and the cap relative to the other, decreasing the distance between the bottom of the container and the lower end of the fracturing member and coupling the first portion of the cap to the container.

In yet another exemplary embodiment of the present disclosure, a method of fracturing samples in a container is provided, The method comprising the steps of positioning a cap relative to the container; and coupling the cap to the open end of the container, the cap including a first portion and a second portion, wherein when the cap is coupled to the open top of the container, the first portion extends over the open end of the container and the second portion extends through the interior of the container and includes a fracturing member, a lower end of the fracturing member being proximate to the bottom of the container, the lower end of the fracturing member being in a fixed position relative to the first portion of the cap.

The above mentioned and other features of the invention, and the manner of attaining them, will become more apparent and the invention itself will be better understood by reference to the following description of embodiments of the invention taken in conjunction with the accompanying drawings.

### BRIEF DESCRIPTION OF THE DRAWINGS

FIG. 1 illustrates an exemplary embodiment of a container in which a sample has been placed;

FIG. 2 illustrates an exemplary cap including an exemplary embodiment of a fracturing member;

FIGS. 3A and 3B illustrate other exemplary embodiments of fracturing members;

FIG. 4 illustrates an empty exemplary container coupled to the exemplary cap of FIG. 2;

FIG. 5 illustrates the exemplary cap of FIG. 2 positioned above the exemplary container of FIG. 1 with the fracturing member extending into the interior of the container;

FIG. 6 illustrates the exemplary assembly shown in FIG. 5 after the exemplary cap has been coupled to the exemplary container, fracturing the sample placed inside;

FIG. 7 illustrates an exemplary arrangement of containers on a container support;

FIG. 8 illustrates an exemplary capping machine for a plurality of test tubs on a rack;

FIG. 9 illustrates an exemplary processing sequence using a capping machine; and

FIGS. 10A-10G illustrate a representative view of an exemplary capping machine for fracturing samples.

### DETAILED DESCRIPTION OF THE DRAWINGS

The embodiments disclosed below are not intended to be exhaustive or to limit the invention to the precise forms disclosed in the following detailed description. Rather, the embodiments are chosen and described so that others skilled in the art may utilize their teachings. While the present disclosure is primarily directed to the preparation of seed samples within a sterile environment, it should be understood that the features disclosed herein may have application to the preparation of other types of samples.

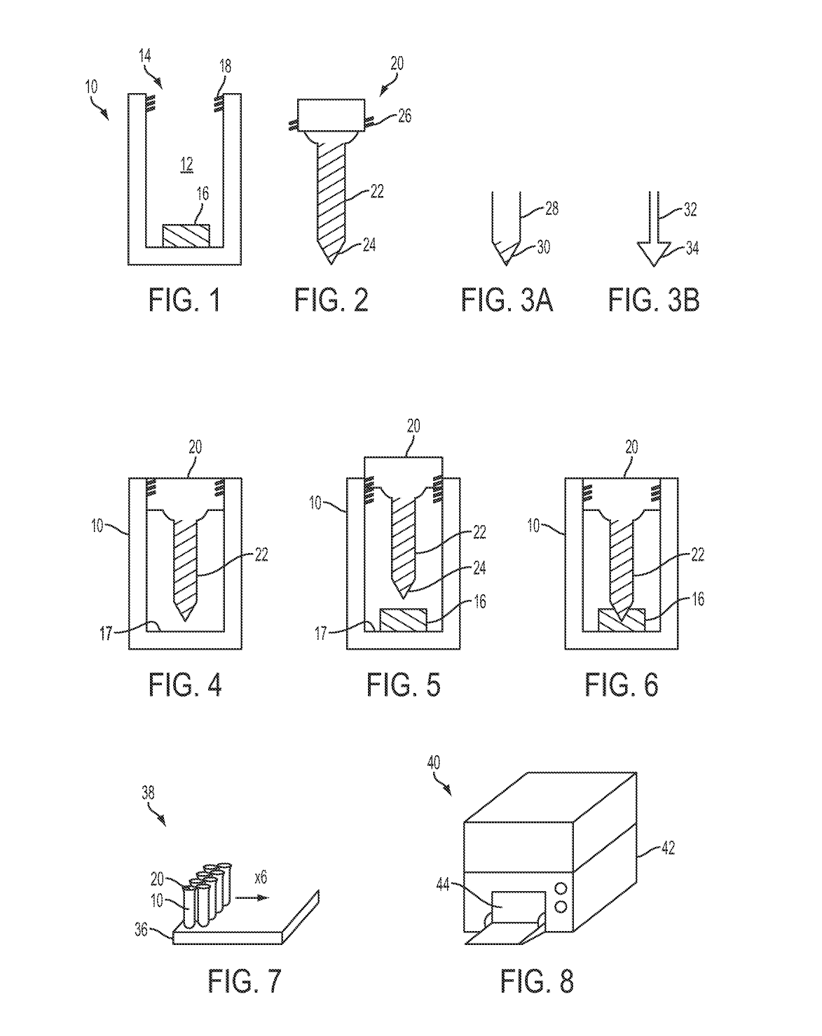

Referring to FIG. 1, a container 10 is shown. In the illustrated exemplary embodiment, container 10 is a test tube. However, other container types and shapes may also be used. In one exemplary embodiment, container 10 is approximately 3 inches in height, shown as D1 in FIG. 4, although other sizes are also contemplated. The container 10 defines an interior 12 accessible through an open end 14. Although a container with a flat bottom is shown, other configurations such as a rounded or a pointed bottom are also contemplated. A sample 16 is shown placed in the interior 12 of the container 10 through open top 14. In one example embodiment, the sample 16 has a hard exterior. An exemplary hard exterior sample is a seed, such as a corn kernel.

Also shown in the illustrated embodiment of FIG. 1, threads 18 are provided on the interior 12 of container 10. In another example embodiment, threads 18 are provided on the exterior of the container 10. In yet another embodiment, no threads are on the container 10.

Referring to FIG. 2, a cap 20 for the container 10 is shown. In one example embodiment, the cap 20 includes a first portion for removably coupling the cap 20 to the container 10 and a second portion including a fracturing member 22 extending downward from the first portion 21. An engaging portion 24 is located at a lower end of the fracturing member 22.

In one embodiment, the second portion 23 of the cap 20, including the fracturing member 22, is in a fixed position relative to the first portion 21 of the cap 20. In another embodiment, the lower end of the fracturing member 22 is in a fixed position relative to the first portion of the cap 20. In still another embodiment, the engaging portion 24 is in a fixed position relative to the first portion 21 of the cap 20.

In the illustrated embodiment, the second portion 21 of the cap 20 including the fracturing member 22 is rigidly attached to the cap 20. In one example embodiment, the fracturing member 22 is attached using a press fit. Other attachments are contemplated, some examples including glue or molding the cap 20 around the fracturing member 22. In one embodiment, the fracturing member 22 is removably coupled to the first portion 21. In one example, fracturing member 22 and the first portion 21 have threaded portions which cooperate to couple the fracturing member to the first portion 21. In one embodiment, the first portion 21 and second portion 23 of the cap 20 including the fracturing member 22 are a unitary device.

In the illustrated embodiment shown in FIG. 2, cap 20 includes threads 26 on the outside of the cap 20. Threads 26 cooperate with thread 18 of container 10 to couple cap 20 to container 10. In the illustrated embodiment, threads 26 are on the exterior of the cap 20 to engage with threads 18 on the interior of the container 10. In one embodiment, threads 26 are on the interior of the cap 20 to engage with threads 18 on the exterior of the container 10.

Other methods of coupling the container 10 to a cap 20 besides using threads, such as press-fit, friction fit, and tongue and groove are also contemplated. Further, cap 20 may engage portions of container 10 not proximate to open end 14 to couple cap 20 to container 10. In one embodiment, an additional component positions cap 20 relative to container 10 such that fracturing member 22 engages a sample within the interior 12 of container 10.

In one example embodiment, the fracturing member 22 is a screw attached to the first portion 21 of the cap 20. In one example embodiment, the screw is a flat-head wood screw, such as a number 6, ½ inch wood screw attached to the first portion 21 of the cap 20. Other sizes and types of screws may also be used. In another example embodiment, the fracturing member 22 is not a screw, but is unitary with the first portion 21 of the cap 20.

In other example embodiments, the fracturing member 22 is of the type shown in either FIGS. 3A and 3B. FIG. 3A shows an example alternative fracturing member 28 in which only the bottom engaging portion 30 is threaded. FIG. 3B shows a second example alternative fracturing member 32 in which the engaging portion 34 is spear shaped. Other designs for a fracturing member that include an engaging portion at one end are also contemplated and may be used depending on the size and material of the sample.

In one embodiment, fracturing member 22 is shaped to press against the hard exterior of a sample 16 and to penetrate or otherwise crack the hard exterior of the sample. In one embodiment, container 10 includes a protrusion which engages sample 16 and sample 16 is pressed against the protrusion to crack the hard exterior of the sample.

Referring next to FIG. 4, an assembly of an empty container 10 and cap 20 with the cap 20 coupled to the container 10 is shown. Fracturing member 22 extends downward into the interior 12 of the container 10.

Referring next to FIG. 5, an assembly of an empty container 10 and cap 20 with the cap 20 positioned above a container 10 in which a sample 16 has been placed. In this position, the fracturing member 22 has not yet engaged the sample 16 to fracture the sample 16. In one embodiment, the container 10 is shaped to generally position the sample 16 under the fracturing member 22. In the illustrated embodiment, the diameter of the interior of container 10 is selected to generally position the sample 16 under the fracturing member 22.

Referring next to FIG. 6, the container 10 is shown with the cap 20 coupled to container 10 in which sample 16 has been placed. The coupling of cap 20 and container 10 engages the engaging tip 24 of fracturing member 22 into the sample 16, fracturing the sample 16. Although FIGS. 5 and 6 illustrate one embodiment of coupling the container 10 with the cap 20 with threads 18 and 26, other methods are also contemplated.

In the illustrated embodiment shown in FIGS. 5 and 6, a length of the fracturing member 22 is selected to engage and fracture the sample when the cap and container are assembled. As shown in FIG. 6, the engaging portion 24 of fracturing device 22 is spaced apart from a bottom, interior surface 17 of container 10. In one example embodiment, the distance between the lower end of the fracturing member 22 and the bottom surface 17 of the container 10, shown as D2 on FIG. 4, is up to about 0.5 inches when cap 20 is coupled to container 10. In another example embodiment, the distance between the lower end of the fracturing member 22 and the bottom surface 17 of the container 10, shown as D2 on FIG. 4, is up to about 0.1 inches. In still another example embodiment, the distance between the lower end of the fracturing member 22 and the bottom surface 17 of the container 10, shown as D2 on FIG. 4, is up to about 25% of the height of the container, shown as D1 on FIG. 4. In yet another example embodiment, the distance between the lower end of the fracturing member 22 and the bottom surface 17 of the container 10, shown as D2 on FIG. 4, is up to about 10% of the height of the container, shown as D1 on FIG. 4. In still yet another example embodiment, the distance between the lower end of the fracturing member 22 and the bottom surface 17 of the container 10, shown as D2 on FIG. 4, is up to about 5% of the height of the container, shown as D1 on FIG. 4.

Referring now to FIG. 7, one example embodiment of a container support 36 holding a plurality of containers 38 is shown. In some embodiments, each of the containers 10 in the plurality of containers 38 includes a cap 20. In one example embodiment, the plurality of containers 38 is a plurality of test tubes. Other container types, shapes, and sizes of containers 10 are also contemplated. FIG. 7 shows a pattern of 48 containers 10 on a container support 38, but other quantities and arrangements of containers 10 are also contemplated. In the illustrated embodiment, container support 36 is a test tube rack which includes a plurality of recesses, each sized to receive and support a respective test tube such that the respective test tube is spaced apart from adjacent test tubes and is generally vertically oriented.

FIG. 8 illustrates an exemplary capping machine 40. Capping machine 40 includes a housing 42 and a container interface 44 which receives a container support 36. In one embodiment, container interface 44 is a rotatable platform onto which container support 36 is placed. In one embodiment, container interface 44 is a conveyor system which transports the container support 36. An exemplary automatic capping machine is the Capit-All brand screw cap tube capper/decapper available from Thermo Fisher Scientific Inc. in Waltham, Mass. Other methods for coupling and/or decoupling the containers 10 and caps 20 are also contemplated. Other example methods of coupling the containers 10 and caps 20 include pressing the caps 20 onto the containers 10, rotating the caps 20 by hand, or using a power drill or other handheld instrument.

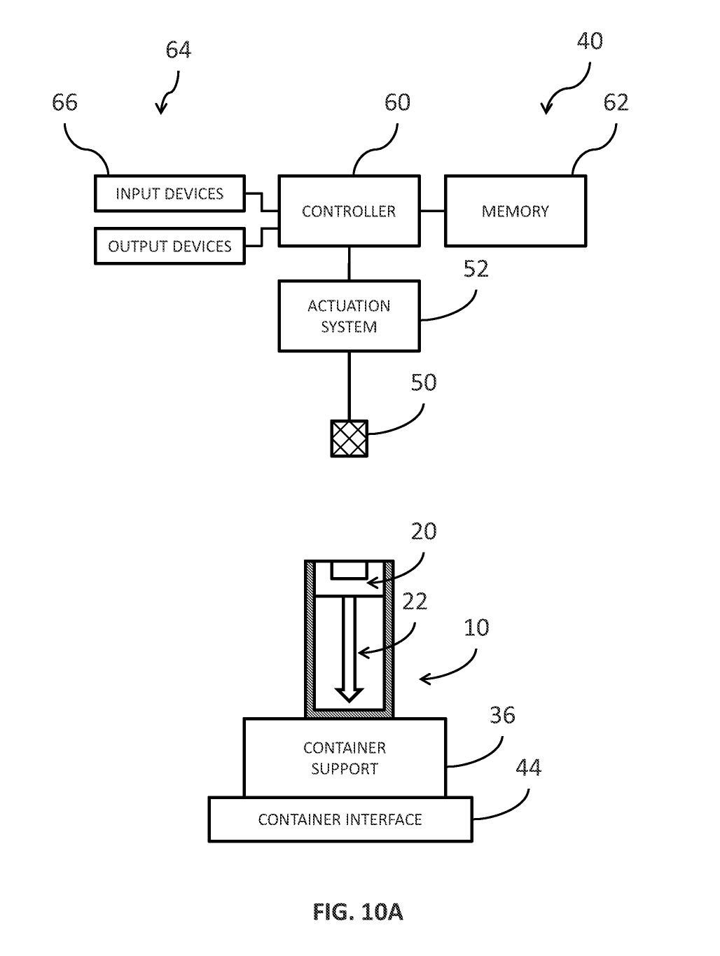

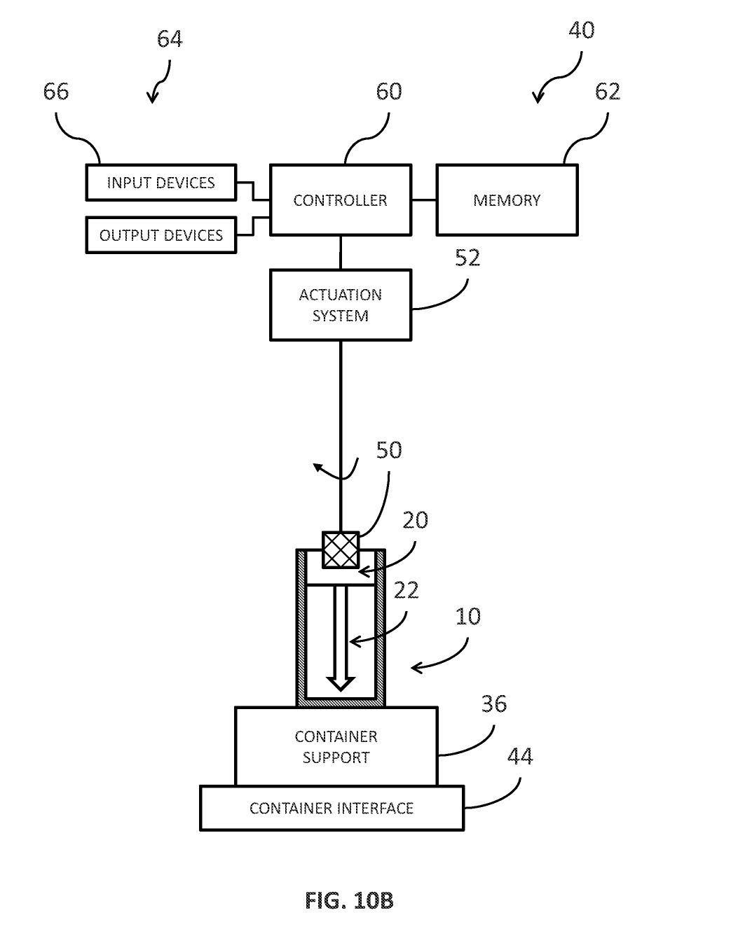

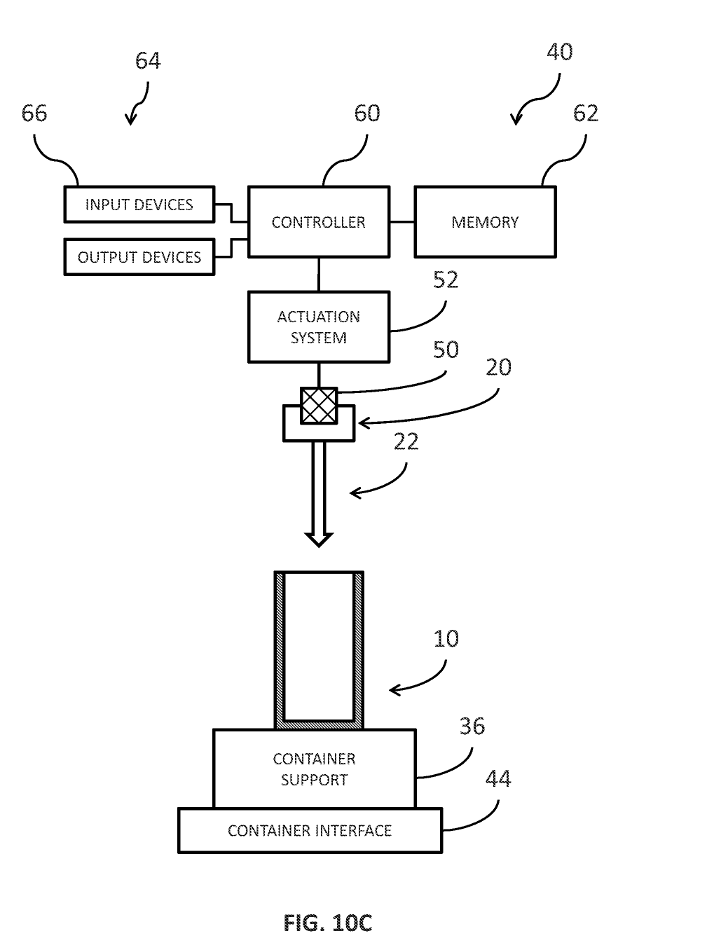

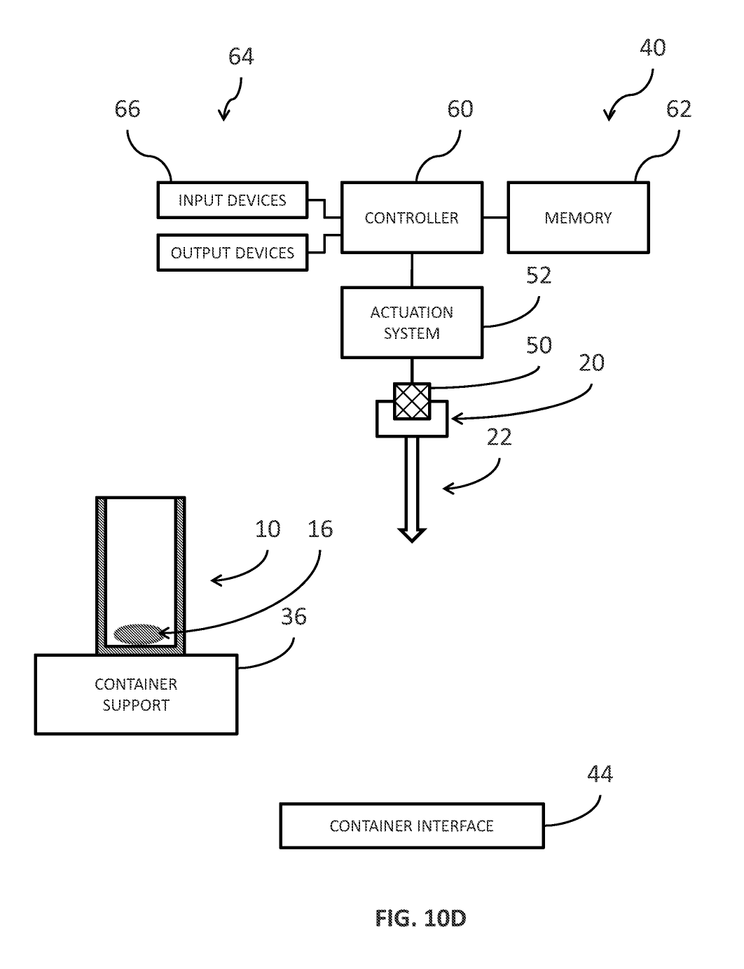

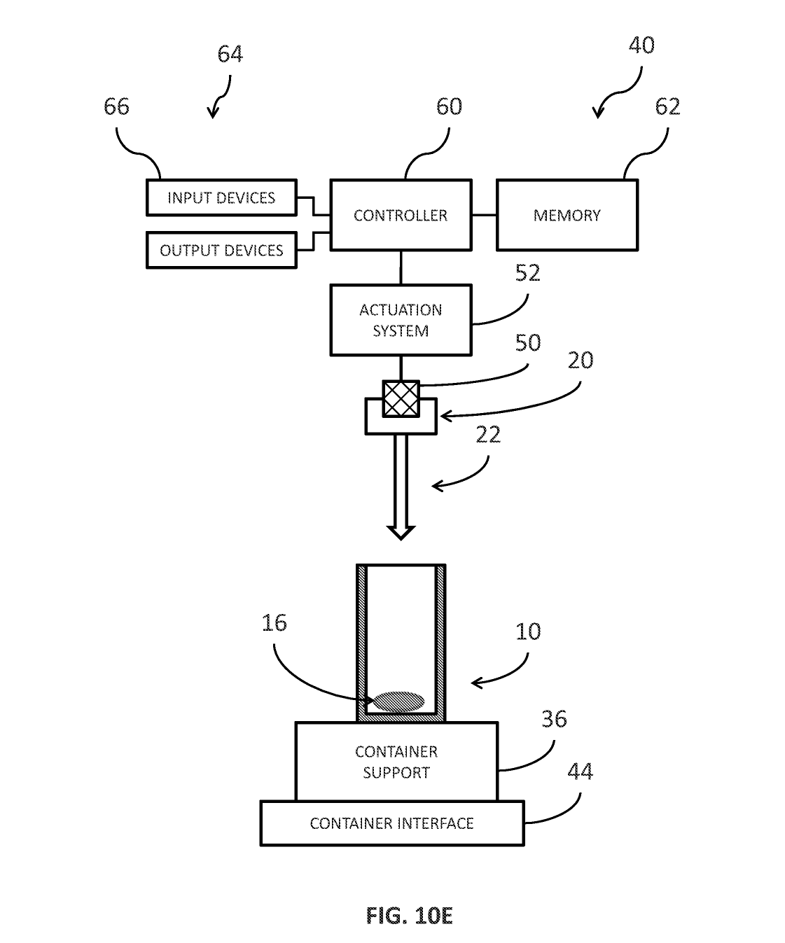

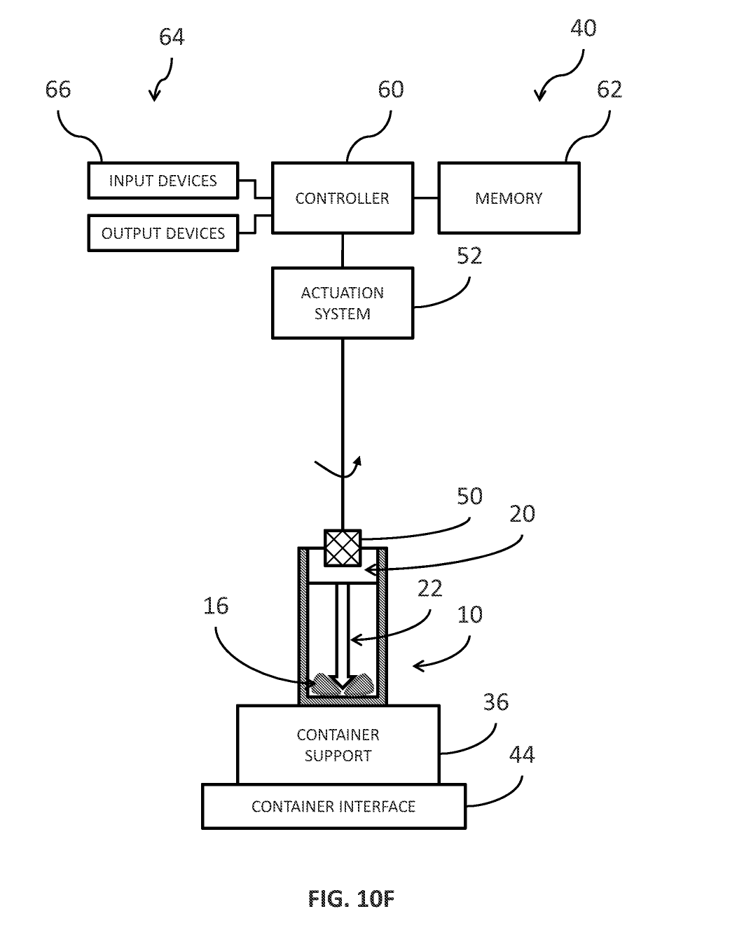

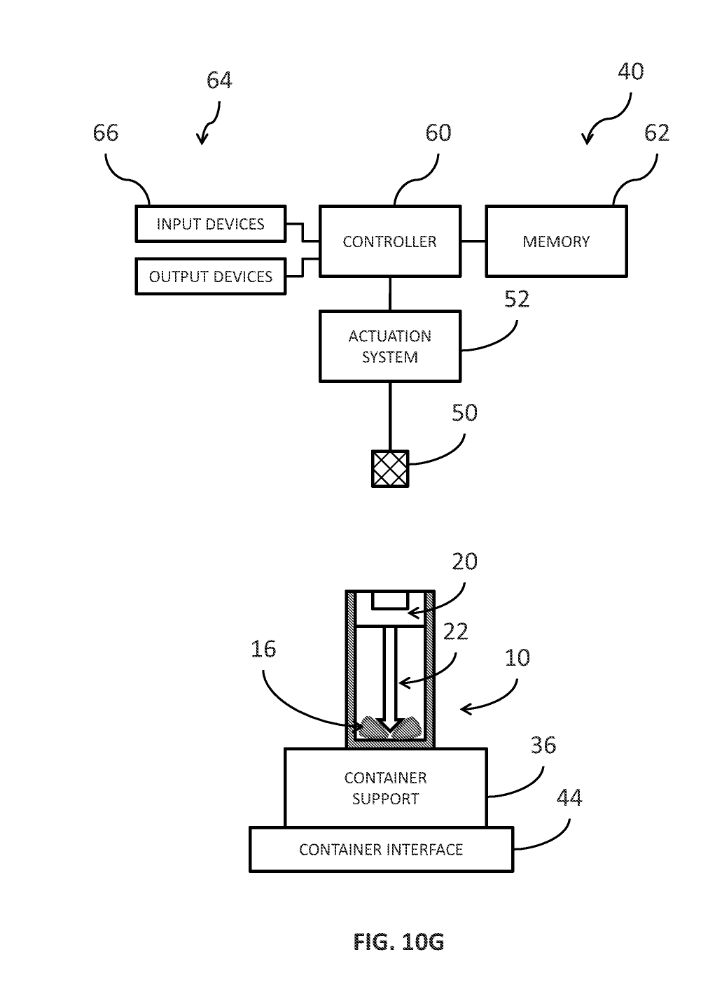

Referring to FIG. 10A, a representative view of an exemplary capping machine 40 is shown. Capping machine 40 includes a container interface 44, which is shown supporting container support 36. Capping machine 40 further includes a cap support 50 which engages cap 10. Exemplary cap supports include systems to support a cap 20 including a mechanical system, a vacuum system, and other suitable system for supporting cap 20. In one embodiment, cap support 50 supports a cap 20 over a container 10 in a spaced apart relationship, the cap 20 being oriented so that fracturing member 22 may be received in the interior of container 10. An exemplary mechanical system interfaces with grooves on cap 20 to grip or hold cap 20. An exemplary cap support 50 is provided as part of the Capit-All brand screw cap tube capper/decapper available from Thermo Fisher Scientific Inc. in Waltham, Mass. In one embodiment, capping machine 40 includes a plurality of tools 50 which engage respective caps 10 of a plurality of containers 10.

Capping machine 40 further includes an actuation system 52 which moves cap support 50. In one embodiment, actuation system 52 moves cap support 50 relative to cap 20 and moves cap support 50 and actuation system 52 together. In one embodiment, actuation system 52 moves cap 20 to cause cap 20 to become coupled to container 10 or uncoupled from container 10. In an example wherein container 10 and cap 20 include cooperating threads, actuation system 52 rotates cap support 50 and hence cap 20 in a first direction such that the threads on cap 20 engage the threads on container 10 and in a second direction such that the threads on cap 20 disengage from the threads on container 10. An exemplary actuation system 52 is provided as part of the Capit-All brand screw cap tube capper/decapper available from Thermo Fisher Scientific Inc. in Waltham, Mass. In one embodiment, container interface 44 moves container 10 to cause container 10 to become coupled to cap 20 or uncoupled from cap 20.

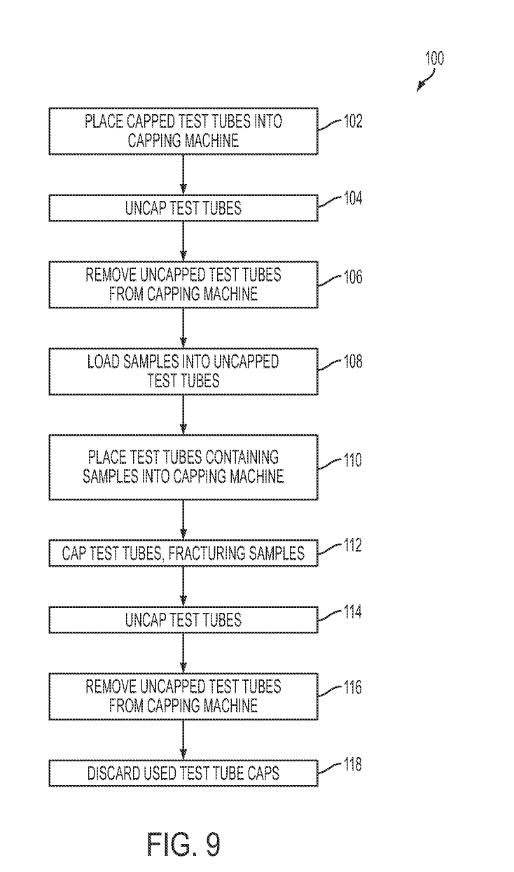

In the illustrated embodiment, capping machine 40 further includes a controller 60 which controls the operation of the actuation system 52. In one embodiment, controller 60 is an electronic controller. An exemplary processing sequence 100 of controller 60 is provided in FIG. 9. Controller 60 may execute software stored on a memory 62 which is accessible by controller 60 to perform one or more portions of processing sequence 100. Controller 60 may include a hardware implementation to perform one or more portions of processing sequence 100. In one embodiment, controller 60 includes one or more processors which execute software stored on one or more memories 62.

Memory 62 is a computer readable medium and may be a single storage device or may include multiple storage devices, located either locally with controller 60 or accessible across a network. Computer-readable media may be any available media that may be accessed by controller 60 and includes both volatile and non-volatile media. Further, computer readable-media may be one or both of removable and non-removable media. By way of example, computer-readable media may include, but is not limited to, RAM, ROM, EEPROM, flash memory or other memory technology, CD-ROM, Digital Versatile Disk (DVD) or other optical disk storage, magnetic cassettes, magnetic tape, magnetic disk storage or other magnetic storage devices, or any other medium which may be used to store the desired information and which may be accessed by controller 60. In one embodiment, controller 60 communicates data, status information, or a combination thereof to a remote device for analysis.

Capping machine 40 further includes one or more I/O modules 64 which provide an interface between an operator and capping machine 40. Exemplary I/O modules 64 include input members 66 and output members 68. Exemplary input members 66 include buttons, switches, keys, a touch display, a keyboard, a mouse, and other suitable devices for providing information to controller 60. Exemplary output devices 68 include lights, a display (such as a touch screen), printer, speaker, visual devices, audio devices, tactile devices, and other suitable devices for presenting information to an operator.

Referring to FIG. 9, an exemplary processing sequence 100 is shown. In the exemplary processing sequence, containers 10 are provided with caps 20 already coupled thereto. In other embodiments, caps 20 are spaced apart from the containers.

The capped containers 10 are loaded into a container support 36, if not already so situated. The capped containers are loaded into the container interface 44 of capping machine 40, as represented by block 102. Referring to FIG. 10A, capping machine 40 positions the capped containers 10 generally under cap support 50. This may be performed by the movement of container support 36 by container interface 44, the movement of cap support 50 by actuation system 52, or a combination thereof.

Capping machine 40 removes the cap 20 from container 10, as represented by block 104. Referring to FIG. 10B, cap support 50 engages cap 20. Actuation system 52 rotates cap 20 relative to container 10 to uncouple cap 20 from container 10. Once uncoupled, cap 20 is raised relative to container 10 by cap support 50 and actuation system 52. At this point, the uncapped container 10 may be removed from capping machine 40, as represented by block 106.

Sample 16 is loaded into the respective containers 10 as illustrated in FIG. 10D and as represented by block 108. In one embodiment, the sample 16 has a hard exterior. Exemplary samples include seeds such as maize kernels, soybeans, cotton seeds, wheat seeds, canola seeds, sunflower seeds, sorghum seeds, rice, and grass seeds.

The container 10 and container support are loaded again into capping machine 40, as represented by block 110. Referring to FIG. 10E, the container 10 is positioned below the respective cap 20. Actuation system 52 moves cap 20 downward relative to container 10 and couples cap 20 to container 10, as illustrated in FIG. 10F and as represented by block 112. The downward movement of cap 20 causes fracturing member 22 to engage and fracture sample 16. Actuation system 52 may rotate the cap 20 a predetermined number of rotations, or may rotate the cap 20 until a predetermined torque is reached for each cap.

In one embodiment, the caps 20 remain in place after fracturing until removed by an operator. In one embodiment, capping machine 40 removes caps 20 after sample 16 have been fractured, as illustrated in FIG. 10G and as represented by block 114. The uncapped containers are removed from capping machine 40, as represented by block 116.

In one embodiment, caps 20 are disposable and are discarded by capping machine 40, as represented by block 118. In one embodiment, cap 20 are reusable and are cleaned by capping machine 40 or otherwise stored by capping machine 40 for later cleaning.

In one embodiment, once sample 16 is fractured, sample 16 may be further ground to homogenize the sample 16. Exemplary further grinding may be performed with a geno-grinder or similar bead-mill type of equipment. In one embodiment, the fracturing member 22 is made of a material that may be ground with a geno-grinder or similar bead-mill type of equipment. As such, if the fracturing member 22 inadvertently breaks during the fracturing process of the sample 16, the fracturing member 22 may be ground with the sample.

In one embodiment, an empty container 10 and cap 20, such as shown in FIG. 4 is provided. In one example embodiment, the container 10 is positioned in a container support 36 which positions the container in a first orientation. In another example embodiment, the cap is supported by a cap support 39. The cap 20 is removed from the container 10 and supported by a cap support 39. In one example embodiment, an actuator is used to remove the cap from the container. In another example embodiment, the actuator is part of capping machine 40.

In one embodiment, a sample 16 is placed in the interior 12 of an empty container 10. In one example embodiment, the sample 16 is placed in the interior 12 of the container 10 manually. In another example embodiment, the sample 16 is placed in the interior 12 of the container 10 by capping machine 40. Once a sample 16 has been placed in the interior 12 of the container 10, the container 10 is coupled to the cap 20, fracturing the sample 16 with the fracturing member 22. In still another example embodiment, a lower end of the fracturing member 22 is in a fixed position relative to a first portion 21 of the cap 20. In yet still another example embodiment, an actuator changes the orientation of one of the container and the cap relative to the other and decreases the distance between the bottom of the container and the lower end of the fracturing member on the cap, fracturing the sample 16 inside the container 10. Example coupling methods include using an automatic capping machine, rotating the cap 20 by hand or using a power drill.

In still another example embodiment, the cap 20 is removed from the container 10 after the sample 16 has been fractured, leaving the sample 16 in the interior 12 of the container 10. In yet still another example embodiment, the cap 20 is disposed of after removal, reducing the chance of contamination between samples.

In another example embodiment, a plurality of empty containers 10 and caps 20, such as shown in FIG. 4 are provided in a container support 36. The automatic capping machine 40 is used to remove the caps 20 from the containers 10.

In one example embodiment, a sample 16 is placed in the interior 12 of each of the empty containers 10, as shown in FIG. 1. In one example embodiment, the samples are placed in the interior 12 of each of the empty containers 10. In another example embodiment, a capping machine 40 places the samples in the interior 12 of each of the empty containers 10. In still another example embodiment, the samples 16 may be placed in the interior 12 of each of the containers 10 substantially simultaneously through the use of a multiple sample tool. In yet still another example embodiment, the samples 16 may be placed in the interior 12 of each of the containers 10 substantially serially by placing the samples 16 into the containers 10 one at a time.

In another example embodiment, once the samples 16 have been placed in the interior 12 of the containers 10, the rack 36 is placed back in the capping machine 40. The capping machine 40 then couples the container 10 and cap 20, fracturing the sample 16 with the fracturing member 22 rigidly attached to the cap 20.

In still another example embodiment, the capping machine 40 is then used to remove the cap 20 from the container 10 after the sample 16 has been fractured. In yet still another example embodiment, the cap 20 is disposed of, reducing the chance of contamination between samples.

In one example embodiment, multiple samples, such as corn kernels, are fractured simultaneously, increasing efficiency and productivity.

While this invention has been described as relative to exemplary designs, the present invention may be further modified within the spirit and scope of this disclosure. Further, this application is intended to cover such departures from the present disclosure as come within known or customary practice in the art to which this invention pertains.

1. A fracturing apparatus comprising:
a container including a bottom and an open top, an interior of the container being accessible through the open top; and
a cap including a first portion removably coupled to the container and a second portion including a fracturing member extending downward from the first portion, wherein when the cap is coupled to the container the fracturing member extends through the interior of the container and a lower end of the fracturing member is proximate to the bottom of the container, the lower end of the fracturing member being in a fixed position relative to the first portion of the cap.

2. The apparatus of claim 1, wherein the lower end of the fracturing member engages a sample having a hard exterior, the sample being supported by the bottom of the container, to fracture the sample as the cap and container are coupled together.

3. The apparatus of claim 2, wherein the sample is at least one seed.

4. The apparatus of claim 3, wherein the sample is at least one kernel of corn.

5. The apparatus of claim 1 wherein the cap and container are coupled together by rotating at least one of the cap and the container relative to the other.

6. The apparatus of claim 1 wherein the cap is coupled to the open top of the container by threads.

7. The apparatus of claim 1 wherein the cap is coupled to the open top of the container by press-fit.

8. The apparatus of claim 1 wherein the container is a test tube.

9. The apparatus of claim 1 wherein the distance between the lower end of the fracturing member and the bottom of the container is up to about 10% of the height of the container.

10. The apparatus of claim 1 wherein the distance between the lower end of the fracturing member and the bottom of the container is up to about 5% of the height of the container.

11. The apparatus of claim 1 wherein the lower end of the fracturing member is threaded.

12. The apparatus of claim 1 wherein the fracturing member is a screw.

13. The apparatus of claim 1 wherein the lower end of the fracturing member is a spear.

14. A fracturing apparatus comprising:
a container including a bottom and an open top, an interior of the container being accessible through the open top;
a container support which positions the container in a first orientation;
a cap including a first portion removably coupled to the container and a second portion including a fracturing member extending downward from the first portion;
a cap support which supports the cap in a second orientation, wherein in the second orientation the fracturing member is positioned directly over the bottom of the container; and
an actuator which changes the orientation of at least one of the container and the cap relative to the other, decreasing the distance between the bottom of the container and the lower end of the fracturing member and coupling the first portion of the cap to the container.

15. The apparatus of claim 14 further comprising a controller that controls the movement of the actuator.

16. The apparatus of claim 14, wherein when the first portion of the cap is coupled to the container the fracturing member extends through the interior of the container and a lower end of the fracturing member is proximate to the bottom of the container, the lower end of the fracturing member being in a fixed position relative to the first portion of the cap.

17. The apparatus of claim 16, wherein the lower end of the fracturing member engages a sample having a hard exterior, the sample supported by the bottom of the container, to fracture the sample as the cap and container are coupled together.

18. The apparatus of claim 16 wherein the sample is at least one seed.

19. The apparatus of claim 16 wherein the sample is at least one kernel of corn.

20. The apparatus of claim 16 wherein the cap and container are coupled together by rotating one of the cap and the container in relation to the other.

21. The apparatus of claim 16 wherein the cap is coupled to the open top of the container by threads.

22. The apparatus of claim 16 wherein the cap is coupled to the open top of the container by press-fit.

23. The apparatus of claim 16 wherein the container is a test tube.

24. The apparatus of claim 23 wherein the distance between the lower end of the fracturing member and the bottom of the container is up to about 10% of the height of the container.

25. The apparatus of claim 23 wherein the distance between the lower end of the fracturing member and the bottom of the container is up to about 5% of the height of the container.

26. The apparatus of claim 16 wherein the lower end of the fracturing member is threaded.

27. The apparatus of claim 16 wherein the fracturing member is a screw.

28. The apparatus of claim 16 wherein the lower end of the fracturing member is a spear.

29. The apparatus of claim 16 wherein the actuator is an automatic capping machine.

30. A method of fracturing samples in a container, the container including a bottom, an open top, and an interior accessible through the open top, the method comprising the steps of:
positioning a cap relative to the container; and
coupling the cap to the open end of the container, the cap including a first portion and a second portion, wherein when the cap is coupled to the open top of the container, the first portion extends over the open end of the container and the second portion extends through the interior of the container and includes a fracturing member, a lower end of the fracturing member being proximate to the bottom of the container, the lower end of the fracturing member being in a fixed position relative to the first portion of the cap.

31. The method of claim 30 further comprising:
placing a sample in the interior of the container;
wherein, the lower end of the fracturing member engages the sample to fracture the sample as the cap is coupled to the open end of the container.

32. The method of claim 31 further comprising removing the cap from the container.

33. The method of claim 32 further comprising disposing the cap.

34. The method of claim 32 wherein an actuation system controlled by an electronic controller removes the cap from the container.

35. The method of claim 34 wherein the actuation system couples the cap to the open end of the container.

36. The method of claim 31 wherein the sample is at least one seed.

37. The method of claim 31 wherein the sample is at least one kernel of corn.

38. The method of claim 31 wherein the placing step is done automatically.

39. The method of claim 31 further comprising:
placing a second sample in a interior of a second container, the second container including a bottom, and an open top, the interior of the second container accessible through the open top of the second container;
coupling a second cap to the open end of the second container, the second cap including a first portion and a second portion, wherein when the second cap is coupled to the open top of the container, the first portion extends over the open end of the container and the second portion extends through the interior of the container and includes a fracturing member, a lower end of the fracturing member being proximate to the bottom of the container, the lower end of the fracturing member being in a fixed position relative to the first portion of the cap, and the lower end of the fracturing member engages the sample to fracture as the second cap is coupled to the open end of the second container.

40. The method of claim 30 wherein the coupling step includes rotating at least one of the cap and container in relation to the other.

41. The method of claim 30 wherein the container is a test tube.

42. The method of claim 30 wherein the distance between the lower end of the fracturing member and the bottom of the container is up to about 10% of the height of the container.

43. The method of claim 30 wherein the distance between the lower end of the fracturing member and the bottom of the container is up to about 5% of the height of the container.
